(19) United States
(12) Patent Application Publication
(10) Pub. No.: US 2023/0250665 A1
(43) Pub. Date: Aug. 10, 2023

(54) AUTOMATED VEHICLE PARKING SYSTEM

(71) Applicant: Babak Amini, Framingham, MA (US)

(72) Inventor: Babak Amini, Framingham, MA (US)

(21) Appl. No.: 17/668,713

(22) Filed: Feb. 10, 2022

(51) Int. Cl. E04H 6/42; B60L 53/30; E04H 6/14; B65G 17/20

(52) U.S. Cl. CPC E04H 6/424; B60L 53/30; B65G 17/20; E04H 6/14; B65G 2203/041; B65G 2203/0266

(57) ABSTRACT

An automated parking system of the present disclosure includes a rotatable vertical structure having a plurality of hubs (i.e., parking spots), wherein each hub is equipped with at least one electric car charger and a plurality of sensors and IoT devices for guiding vehicles and managing parking spaces. The system can be underground, ground, above ground or halfway above ground and can be configured to connect to one or more tunnels. The structure is designed to rotate to allow for cars to enter a hub. The system can be used for a dual purpose as parking and as highway, street, or tunnel exits. Once cars are parked in several hubs, a few hubs will remain vacant to allow cars to enter the structure from the tunnel and exit the tunnel as the rotary conveyor mechanism transports the hubs from one level to another.

### TECHNICAL FIELD

Embodiments disclosed herein relate generally to an automated vehicle parking system, and more particularly to an automated vehicle parking system that is suitable to receive and hold motor vehicles and can be used as a private or public car parking against payment and can be compatible with a network of underground tunnels.

### BACKGROUND ART

The problem of parking of motor vehicles is becoming more and more pronounced, especially in areas where little space is available for parking motor vehicles by day or by night. Known large underground car garages have been proposed to meet the lack of space available for parking but have not overcome various working aspects of the problem. They are expensive, very difficult to assemble and operate, as well as not efficient in moving vehicles in and out of parking spaces. Additionally, these prior art systems are not scalable and hence cannot meet the demand of ever-increasing number of motor vehicles.

Moreover, these known parking structures are not designed to accommodate self-driving cars entering and exiting underground public transportation systems such as a network of tunnels proposed by the Boring Company which creates safe, fast-to-dig, and low-cost transportation, utility, and freight tunnels to solve traffic, enable rapid point-to-point transportation and transform cities.

Therefore, there is a need for an automated vehicle parking system that solves the mentioned-above shortcomings of the prior art parking systems and can be connected to a network of underground tunnels to accommodate self-driving cars entering and existing the tunnels.

### SUMMARY OF THE EMBODIMENTS

The present invention provides an automated parking system for parking self-driving motor vehicles exiting or entering a tunnel connected to the system. The system includes a first frame support structure having a front frame member and a back frame member; a rotary conveyor system disposed on the first frame support structure; and a plurality of hubs pivotally connected to the rotary conveyor system; wherein the rotary conveyor system is configured to transmit rotary motion between a first shaft connecting a motor and a first chain ring and a second shaft connecting a second chain ring, a third chain ring and a fourth chain ring; wherein a plurality of teeth of the first chain ring and a plurality of teeth of the second chain ring mesh and engage with a driving chain disposed on the back frame member; wherein a plurality of teeth of the third chain ring mesh and engage with an advancing back chain disposed in a back channel of the back frame member; and wherein a plurality of teeth of the fourth chain ring mesh and engage with an advancing front chain disposed in a front channel of the front frame member.

According to some embodiments of the present invention, the front frame member and the back frame member each can terminate in a pair of support legs. In some instances, each pair of support legs can be connected by a corresponding horizontal support member. Additionally, the frame support structure can include a pair of ground support members to ensure overall stability of the system. In some embodiments, the front frame member and the back frame member are connected together by one or more top frame support members. The hubs are each pivotally connected to the front advancing chain and the back advancing chain by one or more pivot members.

According to some aspects of the present invention, a plurality of hubs include at least one sensor such as proximity sensor or at least one transmitter coupled to a computing device having a processor and memory. In some instances, a plurality of hubs includes at least one IoT device in communication with a computing device. And yet in some other instances, a plurality of hubs includes at least one electric car charger to allow for car charging while a car is parked in the hub. In some instances, the system includes at least one additional parking structure disposed back-to-back in close proximity to the first parking structure to allow for scalability. The system can further include one or more bridges connecting the first parking structure and the second parking structure.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the device and method shown where illustration is not necessary to allow those of ordinary skill in the art to understand the device and method.

### BRIEF DESCRIPTION OF THE DRAWINGS

The preceding summary, as well as the following detailed description of the disclosed system and method, will be better understood when read in conjunction with the attached drawings. It should be understood, however, that neither the system nor the method is limited to the precise arrangements and instrumentalities shown.

FIG. 1 is a front perspective view of a disclosed automated vehicle parking system embodying the invention.

FIG. 2 is a back perspective view of the disclosed system.

FIGS. 3A and 3B show a hub for parking a motor vehicle, in accordance with an embodiment of the present invention.

FIG. 3C illustrates a pivotal connection of a hub to a rotary conveyor system.

FIG. 4 is an illustration of alternative configurations of the system of the present invention.

FIG. 5 is a front perspective view of the disclosed system incorporating a plurality of modules for scalability.

FIG. 6 is a back perspective view of the disclosed system incorporating a plurality of modules for scalability.

FIG. 7A is a schematic front view of the disclosed system incorporating a plurality of modules for scalability.

FIG. 7B is a schematic back view of the disclosed system incorporating a plurality of modules for scalability.

FIG. 8A is a schematic left view of the disclosed system incorporating a plurality of modules for scalability.

FIG. 8B is a schematic right view of the disclosed system incorporating a plurality of modules for scalability.

FIG. 9 is a schematic top view of the disclosed system incorporating a plurality of modules for scalability.

FIG. 10 is a schematic bottom view of the disclosed system incorporating a plurality of modules for scalability.

### DETAILED DESCRIPTION OF SPECIFIC EMBODIMENTS

An automated parking system of the present disclosure includes a rotatable vertical structure having a plurality of hubs (i.e., parking spots), wherein each hub is equipped with at least one electric car charger and a plurality of sensors and IoT devices for guiding vehicles and managing parking spaces. The system can be underground, ground, above ground or halfway above ground and can be configured to connect to one or more tunnels such as the Boring Company tunnels, for example. The structure is designed to rotate to allow for cars to enter a hub. The system can be used for a dual purpose as parking and as highway, street, or tunnel exits. Once cars are parked in several hubs, a few hubs will remain vacant to allow cars to enter the structure from the tunnel and exit the tunnel as the rotary conveyor mechanism transports the hubs.

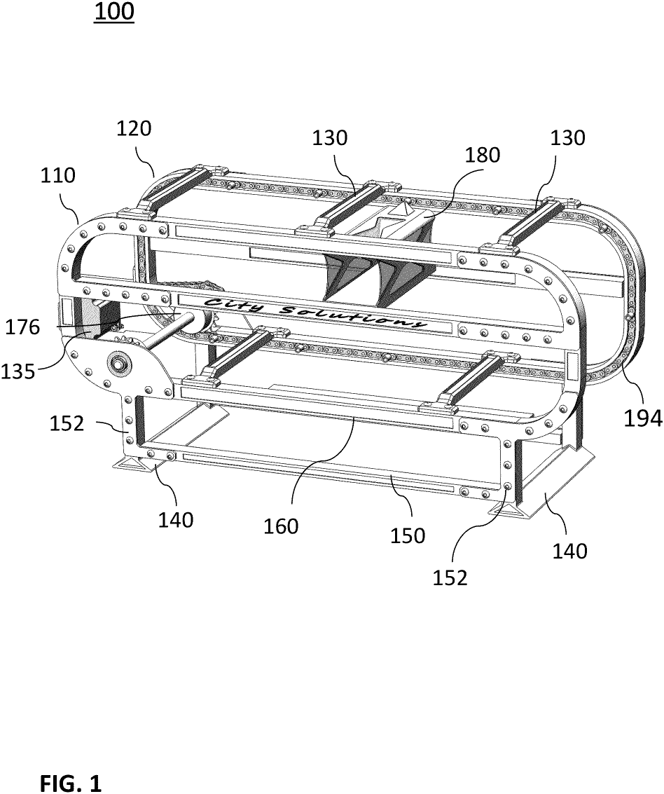

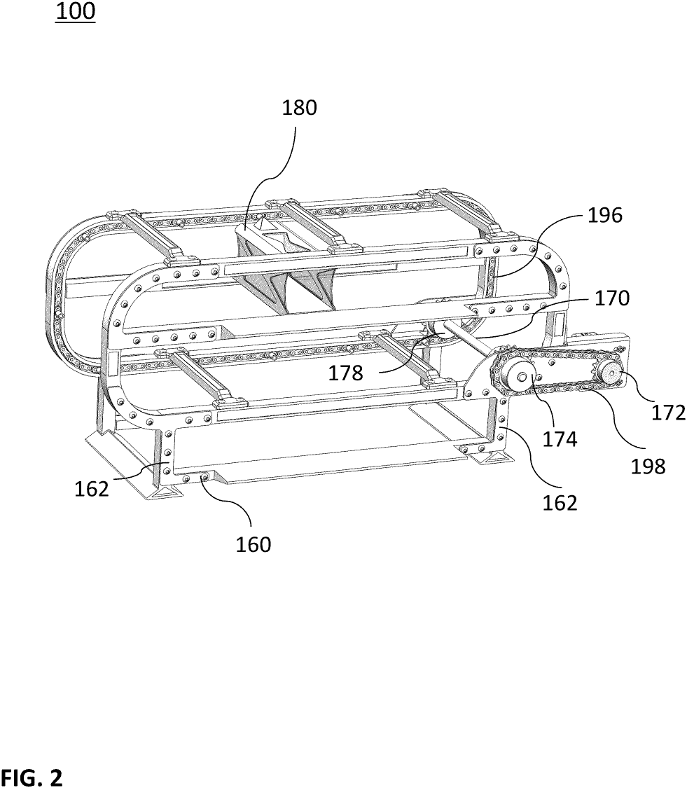

Referring now to the drawings in detail, FIG. 1 shows an automated parking system 100, which includes a vertical frame support structure comprised of front frame member 110 terminating in a pair of support legs 152 and back frame member 120 terminating in support legs 162 shown in FIG. 2. The structure can further include a pair of ground support members 140 to ensure overall stability of the system. A pair of the support legs 152 and 162 can be connected by corresponding horizontal support members 150 and 160. A plurality of hubs 180 are pivotally connected to front advancing chain 194 positioned inside a channel of the front frame member 110 and to back advancing chain 196 positioned inside a channel of the back frame member 120. The rotary conveyor system further includes (disposed on the back frame member 120) first chain ring (sprocket) 172 connected to motor 135 having a power supply (not shown) and second chain ring (sprocket) 174 coupled to the first chain ring 172 by driving chain 198 and a third chain ring 176 coupled to fourth chain ring 178 disposed on the front frame member 110, wherein the second chain ring 174, the third chain ring 176 and the fourth chain ring 178 are all connected by second rotating shaft 170 rotatable about a horizontal axis of rotation extending through the second shaft. The first chain ring 172 can be connected to motor 135 by a first rotating shaft (not shown) rotatable about a horizontal axis of rotation extending through the first shaft. The first, second, third and fourth chain rings (sprockets) are profiled wheels having teeth that mesh and engage with a corresponding chain, the teeth of the first chain ring 172 and the teeth of the second chain ring 174 mesh and engage with the corresponding driving chain 198, the teeth of the fourth chain ring 178 mesh and engage with the corresponding advancing chain 196, and the teeth of the third chain ring 176 mesh and engage with the corresponding advancing chain 194, such that when the first chain ring is being rotated by the motor, it cause the corresponding chain to rotate the second, third and fourth chain rings coupled by the shaft 170 thereby transmitting rotary motion between the first shaft and the second shaft, which in turn causes the advancing chains to move and transport the hubs thereby effectuating a rotary conveyor mechanism. In some instances, instead of a chain, a track or other perforated or indented material can be used. According to some embodiments of the present invention, the diameter of the first chain ring can be smaller than the diameter of the second chain ring. In some instances, the first chain ring can have fewer teeth than the second chain ring, and in some instances, vice versa. In some instances, the front frame member 110 and the back frame member 120 are connected together by one or more top frame support members 130 for reinforcing further the structural integrity of the frame.

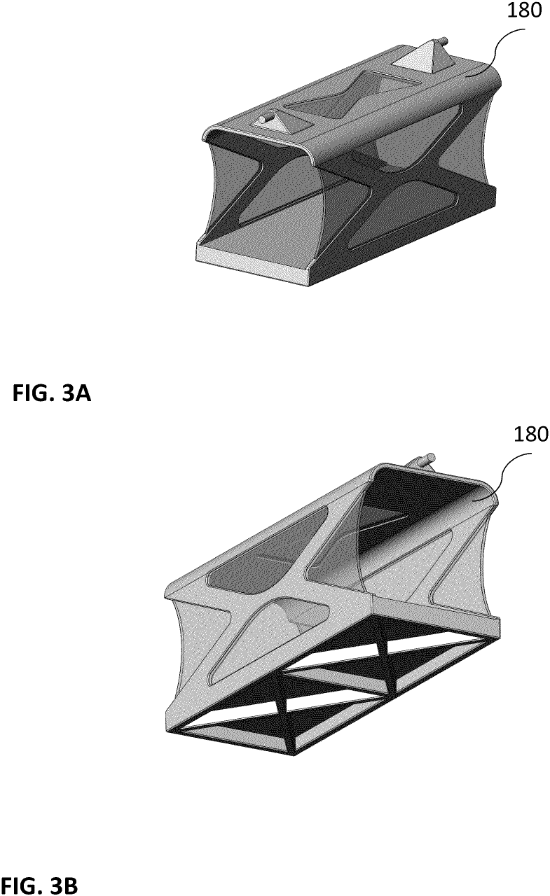

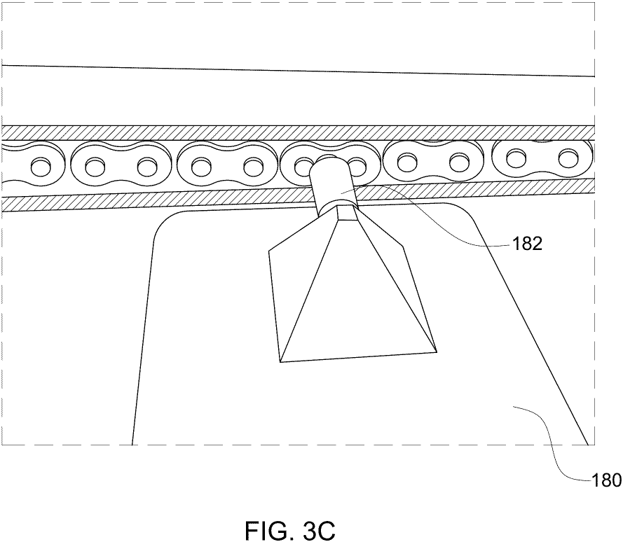

The hubs 180, shown in FIG. 3A and FIG. 3B, each incorporate one or more electric car charges. In some instances, the hubs can include one or more sensors and one or more IoT devices for guiding vehicles and managing parking spaces. The sensors can be proximity sensors and transmitters positioned at each hub and coupled to a computing device having a processor and memory. In some instances, the system can further include a series of cameras backed by computers which are configured to analyze images for keeping track of open/vacant spaces. The hubs 180 each are pivotally connected to the rotary conveyor mechanism’s front advancing chain and back advancing chain by one or more pivot members 182 as shown in FIG. 3C, such that when the chains of the rotary conveyor move, the hubs retain the same vertical position. The hubs 180 can be devoid of entry and exit doors so entering vehicles can freely enter from the front side of the hub and exit from the back side of the hub, or vice versa. According to some embodiments of the present invention, the hubs can have automatic entry and exit doors. In some instances, the hubs can have one door (such entry door, or exit door, for example).

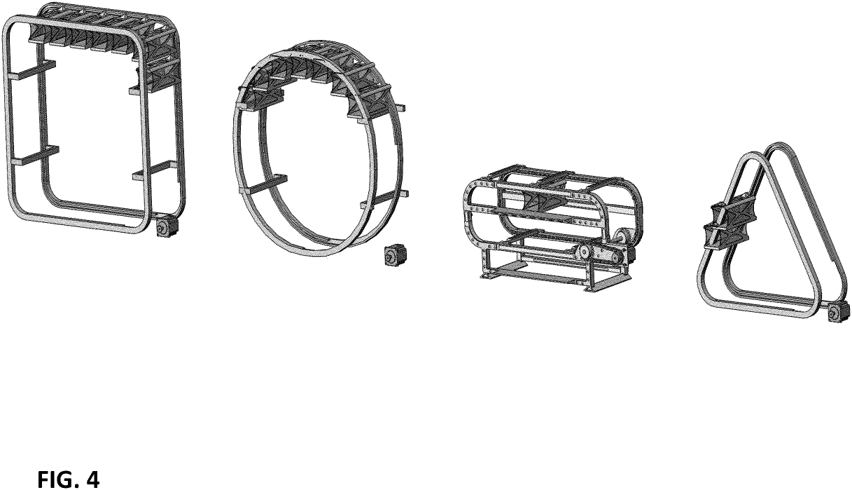

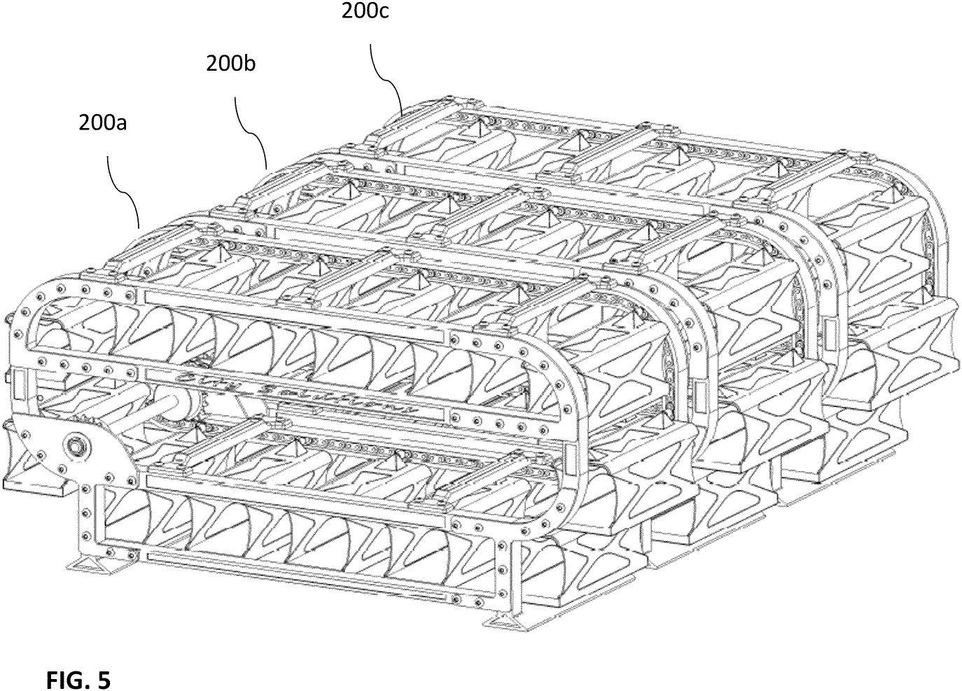

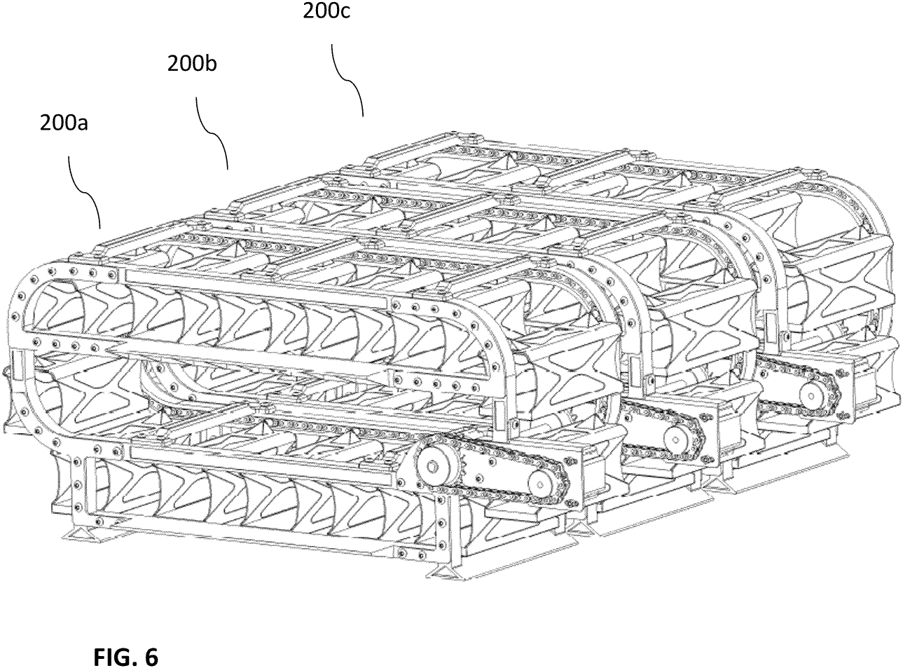

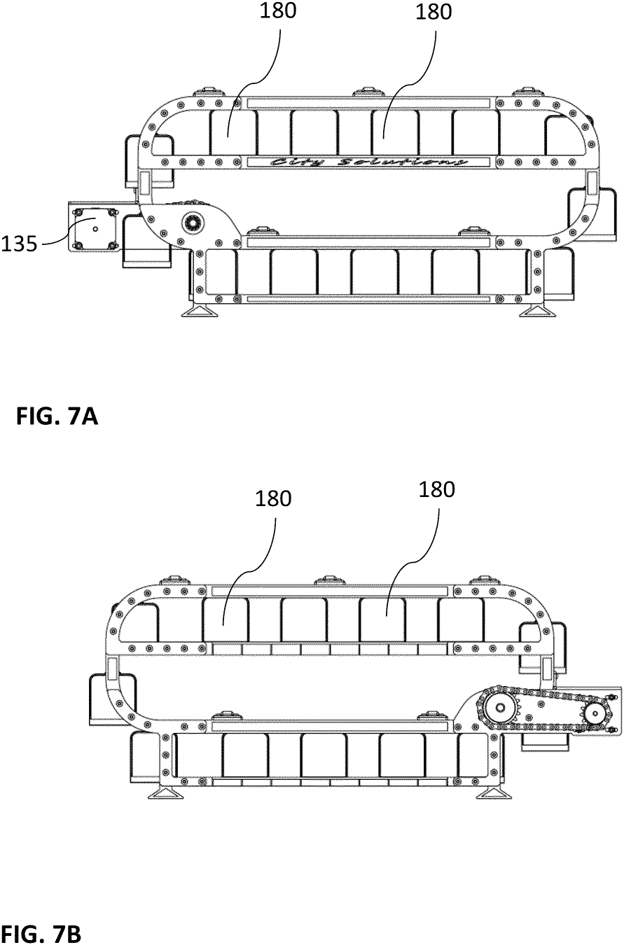

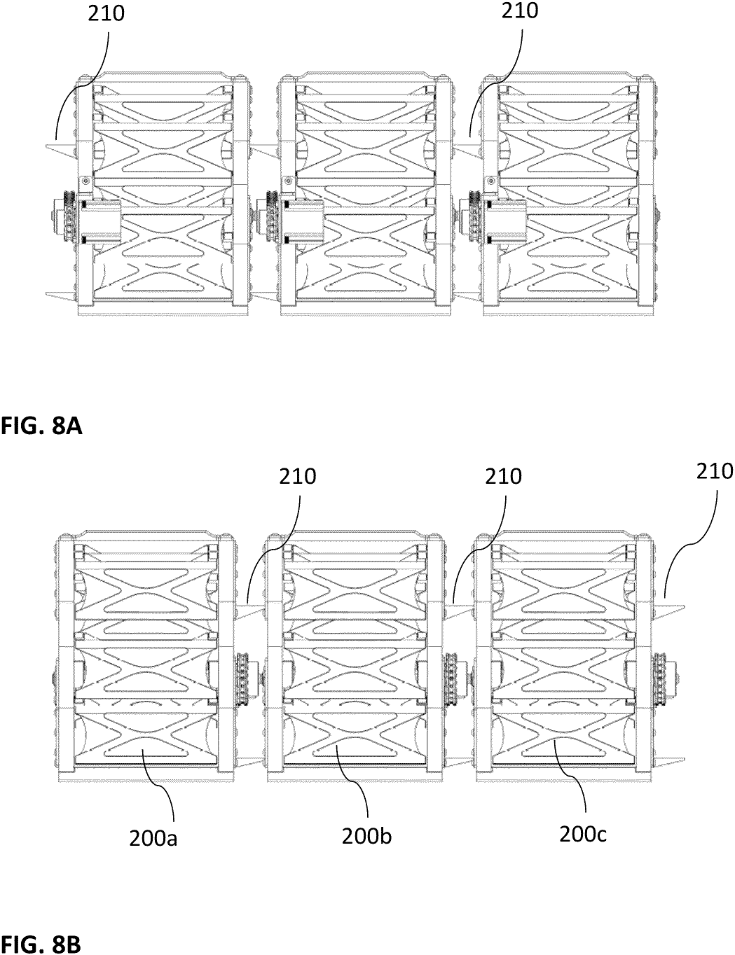

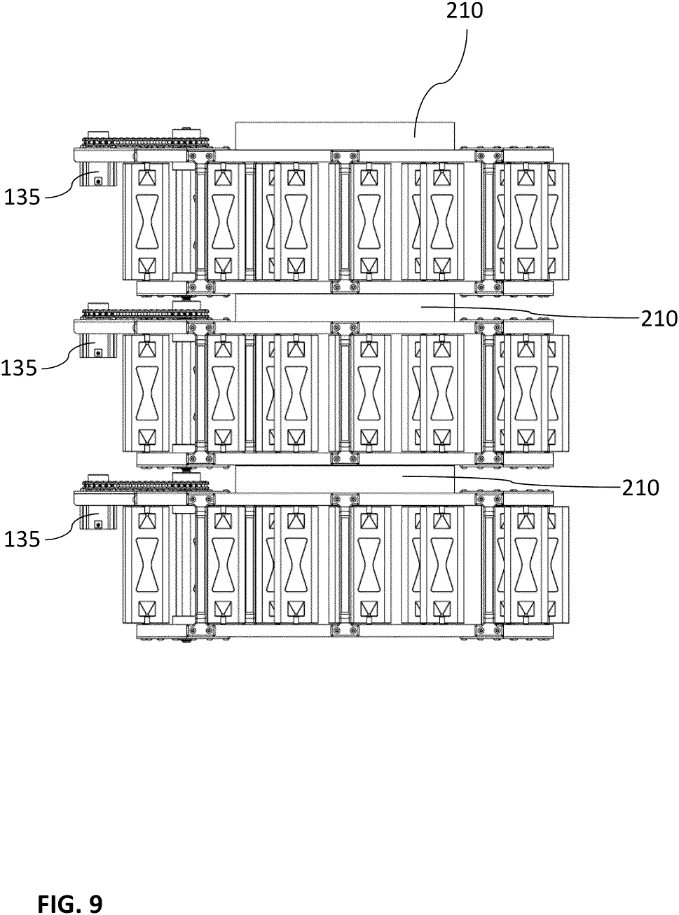

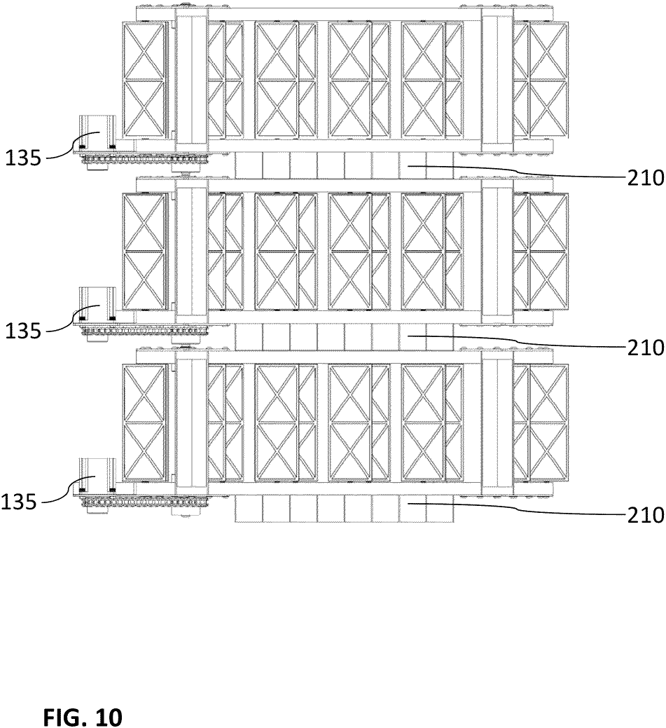

As illustrated in FIG. 4, the parking structure of the present invention can have various shapes, such as circular, rectangular, square, oval, or any other suitable shapes. In some instances, the system can incorporate more than one parking structure as shown in FIGS. 5-10, thus making the system of the present invention easily scalable and accommodating parking for ever increasing number of cars. FIG. 5 is a front perspective view and FIG. 6 is a back perspective view of the disclosed system incorporating assembled back-to-back parking structure 200a, 200b, and 200c. The system is configured to operate each parking structure independently or synchronously, wherein each structure has its own motor-driven rotary conveyor mechanism. The system is configured to align the corresponding hubs of each structure such that the car parked in one structure can freely move to a corresponding hub of another structure as shown in FIGS. 7A-7B, wherein hubs 180 of each structure are aligned with each other. According to some embodiments of the present invention, a plurality of structures can be assembled with no significant gap between neighboring structures. In some instances, the system of the present invention can further include bridges 210 connecting back-to-back structures as shown in FIGS. 9-10, bridging the gap between neighboring structures. In some instances, the system can include two structures assembled back-to-back, in some three as illustrated in FIGS. 5-10, and yet in some other instances more than three (e.g., four, five, six or more).

The system is designed to be connected to one or more underground tunnels such as the Boring Company tunnels, for example. When a self-driving electric car is exiting an underground tunnel into a hub of the parking system of the present invention, the rotary conveyor mechanism can transport the hub from the initial position on the underground level to an upper position on the ground level or in some instances to an above ground level, thereby allowing cars to enter and exit at different levels of interest. Similarly, the system can be designed to allow a car to enter the hub from the ground level and exit the hub into a tunnel from the underground level. In some instances, when a square-shaped structure is utilized, the system can be used to accommodate parallel parking allowing cars to enter the hubs from the ground level and transporting them to below ground levels, thereby expanding parking capacity in comparison with the conventional parallel parking lots.

While at least one exemplary embodiment has been presented in the foregoing detailed description of the invention, it should be appreciated that a vast number of variations exists. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

The foregoing detailed description is merely exemplary in nature and is not intended to limit the invention or application and uses of the invention. Furthermore, there is no intention to be bound by any expressed or implied theory presented in the preceding technical field, background, brief summary, or the following detailed description.

What is claimed is:

1. An automated parking system for parking motor vehicles comprising:
a first frame support structure having a front frame member and a back frame member;
a rotary conveyor system disposed on the first frame support structure; and a plurality of hubs pivotally connected to the rotary conveyor system; wherein the rotary conveyor system is configured to transmit rotary motion between a first shaft connecting a motor and a first chain ring and a second shaft connecting a second chain ring, a third chain ring and a fourth chain ring;
wherein a plurality of teeth of the first chain ring and a plurality of teeth of the second chain ring mesh and engage with a driving chain disposed on the back frame member; wherein a plurality of teeth of the third chain ring mesh and engage with a back advancing chain disposed in a back channel of the back frame member; and wherein a plurality of teeth of the fourth chain ring mesh and engage with a front advancing chain disposed in a front channel of the front frame member.

2. The system of claim 1, wherein the front frame member and the back frame member are connected by one or more top frame support members.

3. The system of claim 1, wherein the hubs are each pivotally connected to the front advancing chain and the back advancing chain by one or more pivot members.

4. The system of claim 1, wherein the front frame member and the back frame member each terminating in a pair of support legs.

5. The system of claim 4, wherein each pair of support legs is connected by a corresponding horizontal support member.

6. The system of claim 1, wherein the frame support structure further comprising a pair of ground support members to ensure overall stability of the system.

7. The system of claim 1, wherein the plurality of hubs are devoid of doors.

8. The system of claim 1, wherein the plurality of hubs comprising at least one door.

9. The system of claim 1, wherein the plurality of hubs comprising at least one electric car charger.

10. The system of claim 1, wherein the plurality of hubs comprising at least one sensor or at least one transmitter in communication with a computing device having a processor and memory, for guiding vehicles and managing parking spaces.

11. The system of claim 1, wherein the plurality of hubs comprising at least one IoT device or at least one camera backed by a computing device, which are configured to analyze images for keeping track of vacant parking spaces.

12. The system of claim 1, further comprising a second frame support structure disposed back-to-back in close proximity to the first support structure and having a rotary conveyor system disposed on the second frame support structure; and a plurality of hubs pivotally connected to the rotary conveyor system; wherein the rotary conveyor system is configured to transmit rotary motion between a first shaft connecting a motor and a first chain ring and a second shaft connecting a second chain ring, a third chain ring and a fourth chain ring; wherein a plurality of teeth of the first chain ring and a plurality of teeth of the second chain ring mesh and engage with a driving chain disposed on the back frame member; wherein a plurality of teeth of the third chain ring mesh and engage with a back advancing chain disposed in a back channel of the back frame member; and wherein a plurality of teeth of the fourth chain ring mesh and engage with a front advancing chain disposed in a front channel of the front frame member.

13. The system of claim 12 further comprising one or more bridges connecting the first frame structure and the second frame structure.
